(19) United States
(12) Patent Application Publication
(10) Pub. No.: US 2025/0129957 A1
(43) Pub. Date: Apr. 24, 2025

(54) CLEANING ASSEMBLY AND METHOD OF MAKING AND USING THE SAME

(71) Applicant: Brian HOSKINS, Jensen Beach, FL (US)

(72) Inventor: Brian HOSKINS, Jensen Beach, FL (US)

(21) Appl. No.: 18/920,565

(22) Filed: Oct. 18, 2024

Related U.S. Application Data
(60) Provisional application No. 63/591,676, filed on Oct. 19, 2023.

(51) Int. Cl. F24F 11/49; B08B 3/08; B08B 9/027

(52) U.S. Cl. CPC F24F 11/49; B08B 3/08; B08B 9/027; F24F 2221/225

(57) ABSTRACT

The present application is directed to a cleaning assembly including: a cleaning agent including at least one of a fungicide, bactericide, viricide, or an algaecide, and an automatic feed apparatus, where the automatic feed apparatus is adapted to feed the cleaning agent at a controlled rate into at least one of a drain tube or a drain pan of an HVAC assembly, where the controlled rate is regulated by an operating parameter of the HVAC assembly

### CROSS REFERENCE TO RELATED APPLICATION

This application claims priority under 35 U.S.C. § 119 (c) to U.S. Provisional Application No. 63/591,676 entitled “CLEANING ASSEMBLY AND METHOD OF MAKING AND USING THE SAME,” by Brian HOSKINS, filed Oct. 19, 2023, which is assigned to the current assignee hereof and incorporated herein by reference in its entirety.

### FIELD OF THE DISCLOSURE

The present disclosure relates to a cleaning assembly, and more particularly to, a cleaning assembly for use in cleaning a drain tube or drain pan of an HVAC assembly.

### RELATED ART

In general, a heating, ventilating, and air conditioning systems (“HVAC”) assembly is an assembly for adjusting temperature, humidity, air current, ventilation, and distribution to optimal conditions for human activities using a cooling or heating cycle, while removing dust and other undesired particulates from the air. A wide range of applications exist for HVAC assemblies. For example, residential, light commercial, commercial, and industrial systems are used to control temperatures and air quality in residences and buildings. Very generally, HVAC assemblies may include circulating a fluid, such as a refrigerant, through a closed loop between an evaporator where the fluid absorbs heat and a condenser where the fluid releases heat. The fluid flowing within the closed loop is generally formulated to undergo phase changes within the normal operating temperatures and pressures of the system so that considerable quantities of heat can be exchanged by virtue of the latent heat of vaporization of the fluid. Conventionally, one hidden medium that fosters the growth of bacteria and mold is the HVAC drip pan, in which condensate from the assembly is collected. If the air conditioner drip pan is not cleaned regularly, it can be a nutritious environment for mold and other deleterious microorganisms, which can affect the efficiency of the HVAC assembly. Therefore, improvements for cleaning these drip pans are of continued importance in the HVAC assembly industry.

### BRIEF DESCRIPTION OF THE DRAWINGS

Embodiments are illustrated by way of example and are not limited in the accompanying figures.

FIG. 1 illustrates a schematic view of a cleaning assembly according to a number of embodiments of the present disclosure.

FIG. 2 illustrates a side cut-away view of a float valve for a cleaning assembly according to a number of embodiments of the present disclosure.

FIG. 3A illustrates a side cut-away view of a drip chamber for a cleaning assembly according to a number of embodiments of the present disclosure.

FIG. 3B illustrates a top view of a drip chamber for a cleaning assembly according to a number of embodiments of the present disclosure.

FIG. 3C illustrates a side cut-away view of a drip chamber extension for a cleaning assembly according to a number of embodiments of the present disclosure.

FIG. 4A illustrates a side cut-away view of a needle valve 480 for a cleaning assembly according to a number of embodiments of the present disclosure.

FIG. 4B illustrates a side view of an alternative embodiment of a needle valve for a cleaning assembly according to a number of embodiments of the present disclosure.

FIG. 4C illustrates a side view of an alternative embodiment of a needle valve for a cleaning assembly according to a number of embodiments of the present disclosure.

FIG. 4D illustrates a side view of a cap component for an alternative embodiment of a needle valve for a cleaning assembly according to a number of embodiments of the present disclosure.

FIG. 4E illustrates a side view of a cap component of a needle valve for a cleaning assembly according to a number of embodiments of the present disclosure.

FIG. 5 illustrates a schematic view of a cleaning assembly and its use with an exemplary HVAC assembly according to a number of embodiments of the present disclosure.

FIG. 6A illustrates a side view of a wicking component for a cleaning assembly according to a number of embodiments of the present disclosure.

FIG. 6B illustrates a side view of a wicking component for a cleaning assembly according to a number of embodiments of the present disclosure.

FIG. 6C illustrates a side view of a wicking component for a cleaning assembly according to a number of embodiments of the present disclosure.

FIG. 6D illustrates a side view of a base for a wicking component for a cleaning assembly according to a number of embodiments of the present disclosure.

FIG. 6E illustrates a side view of a base for a wicking component for a cleaning assembly according to a number of embodiments of the present disclosure.

FIG. 6F illustrates a cut-away view of a base for a wicking component for a cleaning assembly according to a number of embodiments of the present disclosure.

FIG. 6G illustrates a cut-away view of a base for a wicking component for a cleaning assembly according to a number of embodiments of the present disclosure.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings. However, other embodiments can be used based on the teachings as disclosed in this application.

The terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one, at least one, or the singular as also including the plural, or vice versa, unless it is clear that it is meant otherwise. For example, when a single embodiment is described herein, more than one embodiment may be used in place of a single embodiment. Similarly, where more than one embodiment is described herein, a single embodiment may be substituted for that more than one embodiment.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the cleaning assembly arts.

The following disclosure describes cleaning assemblies adapted to achieve improved sanitation of a drip pan or drain tube of an HVAC assembly. The concepts are better understood in view of the embodiments described below that illustrate and do not limit the scope of the present invention.

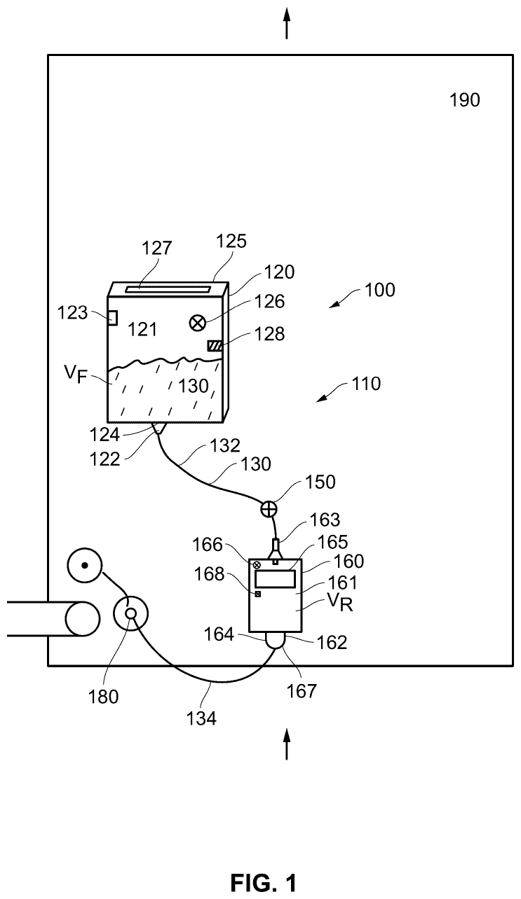

For purposes of illustration, FIG. 1 illustrates a schematic view of a cleaning assembly according to a number of embodiments of the present disclosure. As best illustrated in FIG. 1, the cleaning assembly 100 may be coupled with an HVAC assembly 190 (explained in further detail below). The HVAC assembly may be defined as a heating, ventilating, and air conditioning systems (“HVAC”) assembly for adjusting temperature, humidity, air current, ventilation, and distribution to optimal conditions for human activities using a cooling or heating cycle, while removing dust and other undesired particulates from the air as known conventionally in the art.

As shown in FIG. 1, the cleaning assembly 100 may include an automatic feed apparatus 110 to feed cleaning agent 130 into the HVAC assembly 190. The automatic feed apparatus 110 may include a vessel 120 adapted to house a cleaning agent 130. In a number of embodiments, the cleaning agent 130 may include a fungicide, bactericide, viricide, or an algaecide. In an embodiment, the cleaning agent 130 may contain a chemical composition. In an embodiment, the cleaning agent 130 may contain a fluid. In an embodiment, the cleaning agent 130 may contain a particulate. In a number of embodiments, the chemical composition may be a biocide solution. Such a biocide solution is defined as a chemical substance intended to destroy, deter, render harmless, or exert a controlling effect on any harmful organism (e.g. fungi, bacteria, virus, or algae) by chemical or biological means. In a number of embodiments, the cleaning agent 130 may also be any chemical substance, or combinations thereof, formulated to prevent or eliminate the growth of microorganisms, algae, gunk and/or other solid material that develops on HVAC assemblies, and more particularly, on drain pans and/or drain tubes of the HVAC assemblies. In a number of embodiments, the cleaning agent 130 may include a solution including hydrogen peroxide. In a number of embodiments, the cleaning agent 130 may include a hydrogen peroxide of between 2-50 ppm within the solution.

In a number of embodiments, the vessel 120 can have a void 121 creating an internal volume (or first volume), V_{F}. For purposes of embodiments described herein and as shown best in FIG. 1, the first volume, V_{F}, of the vessel 120 may be at least about 0.1 L, such as, at least about 0.5 L, or at least about 1 L, or at least about 2 L, or at least about 5 L, or even at least about 10 L. According to still other embodiments, the first volume, V_{F}, of the vessel 120 may be not greater than about 100 L, such as, not greater than about 50 L, or even not greater than about 25 L. It will be appreciated that the first volume, V_{F}, of the vessel 120 may be within a range between any of the minimum and maximum values noted above. It will be further appreciated that the first volume, V_{F}, of the vessel 120 may be any value between any of the minimum and maximum values noted above.

In a number of embodiments, as shown in FIG. 1, the vessel 120 may include at least one port 122. In a number of embodiments, the at least one port 122 may include a plurality of ports. In a number of embodiments, the at least one port 122 may allow the cleaning agent 130 to be moved outside of the vessel 120. In a number of embodiments, the at least one port 122 may be adapted for dispensing the cleaning agent 130. In a number of embodiments, the at least one port 122 may include at least one nozzle or needle for dispensing the cleaning agent 130 outside of the vessel 120. In a number of embodiments, the at least one port 122 may include a plurality of nozzles or needles for dispensing the cleaning agent 130 outside of the vessel 120. In a number of embodiments, the at least one port 122 or the vessel 120 may include a filter 124 for filtering the cleaning agent 130. In a number of embodiments, the at least one port 122 or the vessel 120 may include a vent 126 to vent to an environment outside of the vessel 120. In a number of embodiments, the at least one port 122 or the vessel 120 may include a sensor 128 to detect changes of the cleaning agent 130 within the at least one port 122 or the vessel 120. It is contemplated herein that sensor 128 can measure luminescence, fluorescence, incandescence, a change in temperature, a change in pressure, a change in viscosity, a change in flowrate, or any other suitable changing characteristic in the cleaning agent 130 within or as it exits or enters the vessel 120.

In a number of embodiments, the vessel 120 may include an inlet 123 for depositing the cleaning agent 130 within the vessel 120. In a number of embodiments, the inlet 123 may include a bore, spigot, nozzle, or any known variation for feeding cleaning agent 130 into a vessel 120 as known conventionally in the art.

In a number of embodiments, the vessel 120 may include a handle portion 125. In a number of embodiments, the handle portion 125 may be adapted to be held for handling and/or positioning the vessel 120 by a user. In a number of embodiments, the handle portion 125 may include at least one void 127 adapted to allow for grasping the vessel 120 by a user. In a number of embodiments, the handle portion 140 may include a plurality of voids adapted to allow for grasping the cleaning assembly 100 by a user.

The cleaning assembly 100 may further include a reservoir 160 adapted to house the cleaning agent 130. In a number of embodiments, the reservoir 160 may have generally polygonal cross-section (e.g. rectangular). In a number of variations, the reservoir 160 may have a polygonal, oval, circular, semi-circular, or substantially circular cross-section.

In a number of embodiments, the reservoir 160 may be operatively connected to the vessel 120. In a number of embodiments, the reservoir 160 may be operatively connected to the vessel 120 via connector 131. In a number of embodiments, the connector 131 may include a tubing. In a number of embodiments, the reservoir 160 may be operatively connected to the vessel 120 via a first section of tubing 132. In a number of embodiments, the reservoir 160 may be operatively connected to the needle valve via a second section of tubing 134. In a number of embodiments, the tubing 130 may include a fluid regulator 150. The fluid regulator 150 may be any known unit operation for limiting the flow of fluid (e.g. cleaning agent 130) through the tubing 130. The fluid regulator 150 may include a drip chamber, a valve, or may be another type.

Alternatively, in a number of embodiments, the tubing 132 may be substituted and replaced with a wicking component for the connector 131. The wicking component may wick the cleaning agent 130 between components of the cleaning assembly 100 in a similar way to the tubing 132 and may be operatively connected to the vessel 120, reservoir 160, and/or needle valve 180, as well as the HVAC assembly drain pan or drain tube (not shown). In a number of embodiments, the wicking component may wick the cleaning agent 130 from the vessel 120 directly to the drain pan or drain tube. The wicking component may include hydrophilic materials, cationic polymers, anionic polymers, hydrophilic non-ionic materials, and combinations thereof. In a particular embodiment, an exemplary natural substance can include silica, collagen, pectin, gelatin, starch, guar gum, gum Arabic, locust bean gum, gum karaya, alginic acid, sodium or potassium salt. In another particular embodiment, an exemplary synthetic substance can include sodium carboxymethylcellulose (CMC), crosslinked sodium carboxymethylcellulose, crystalline sodium carboxymethyl cellulose, polyvinyl alcohol, polyvinyl pyrollidone, polyethylene glycol, polypropylene glycol, cross-linked dextran, starch-acrylonitrile graft copolymer, starch sodium polyacrylate, gluten, polymer of methyl vinyl ether, maleic acid, metal or ammonium salts of polyacrylic acid or its copolymers, metal or ammonium salts of polystyrene sulfonic acid. In a particular embodiment, the wicking component can include a combination of natural substances, a combination of synthetic substances, or a combination of natural substances and synthetic substances. In a number of embodiments, the wicking component can include a textile, which may be woven or non-woven. The textile may include grass, cotton, flax, hemp, linen, jute, coir, straw, sisal, modal, eucalyptus, rayon, animal hair, fur, skin, or silk, polyester, aramid, acrylic, nylon, polyurethane, polypropylene, lurex, carbon fibre, glass fibre, or may be a different type.

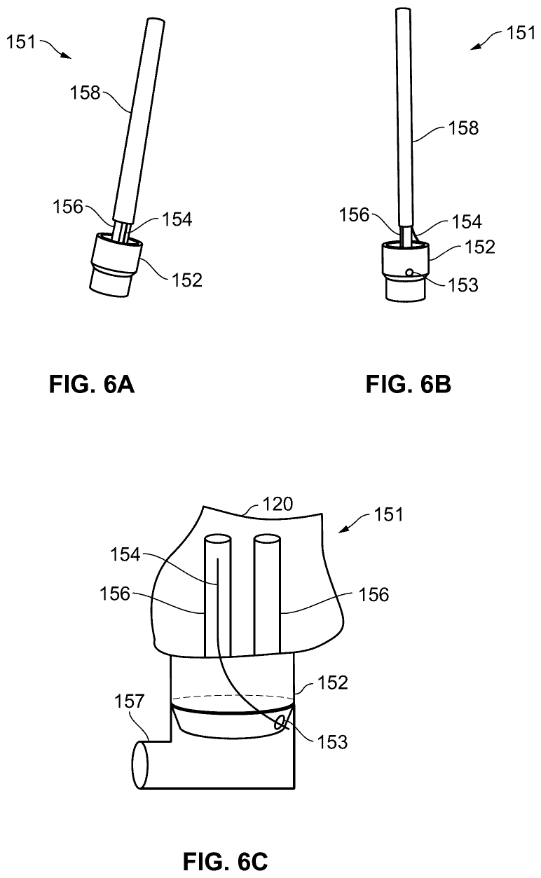

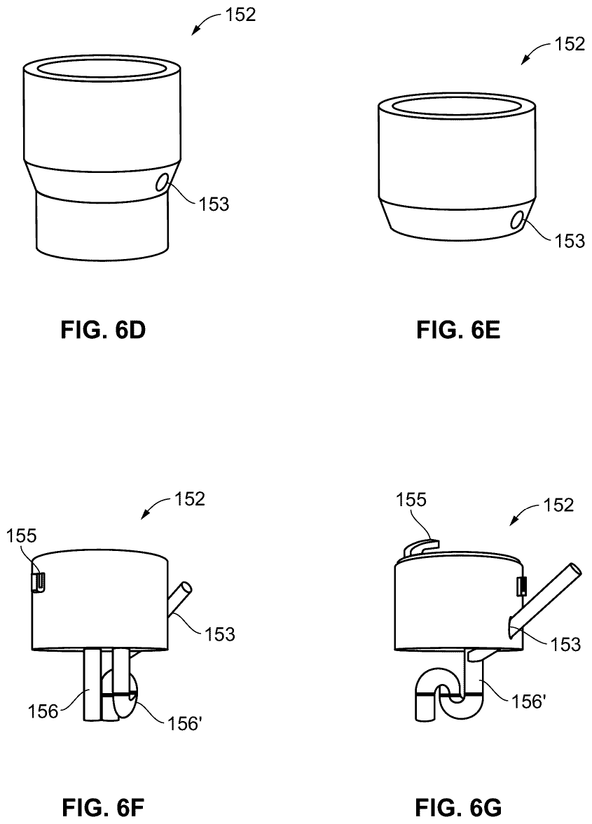

FIGS. 6A-6C illustrate side views of a wicking component according to a number of embodiments. In a number of embodiments, the wicking component 151 may include a base 152, a wick 154, a plurality of tubes 156, and a tube coupling component 158. In a number of embodiments, the plurality of tubes 156 may include a first tube 156 and a second tube 156′. In a number of embodiments, the tubes 156, 156′ may be made of any of the materials listed herein. In a number of embodiments, the second tube 156′ may contain a wick 154, which exits the wicking component 151 through a tube/vent 156/153 in the base 152. The base 152 may further have an optional second vent 155. The wick 154 may be made of any of the materials listed herein. In a number of embodiments, the coupling component 158 may couple the plurality of tubes 156, 156′ together. In a number of embodiments, the coupling component 158 may be made of any of the materials listed herein and may include any of the structures of the coupling components listed herein. In a number of embodiments, the coupling component 158 may be a sleeve as shown.

FIGS. 6D-6E illustrate a side view of a base for a wicking component for a cleaning assembly according to a number of embodiments of the present disclosure. In a number of embodiments, the base 152 may be made of any of the materials listed herein. As shown in FIGS. 6D-6E, the base 152 may have an at least partially cylindrical shape. As shown in FIG. 6D, the base 152 may have a first cylindrical portion, a narrowing portion, and a second cylindrical portion. As shown in FIG. 6E, the base 152 may have a first cylindrical portion and a narrowing portion. In a number of embodiments, the base 152 may include a base coupling component that couples the base 152 with the vessel 120. The coupling component may be made of any of the materials listed herein and may include any of the structures of the coupling components listed herein. In a number of embodiments, referring back to FIG. 6C, the reservoir 120 may be inverted onto the wicking component 151. In a number of embodiments, threadings on the reservoir 120 may couple with threadings on the base 152 of the wicking component 151 such that the reservoir is inverted 120. Further, the base 152 may pair with an L-intersection 157 of tubing or piping that feeds or couples directly to the drain tube within the HVAC assembly. FIGS. 6F-6G illustrate a cut-away view of a base for a wicking component for a cleaning assembly according to a number of embodiments of the present disclosure. For purposes of illustration, FIGS. 6F-6G illustrate the base 152 of FIG. 6E but the base of FIG. 6D is contemplated as including the structure of FIGS. 6F-6G as well. FIG. 6F illustrates a base 152 with a first tubing 156, and a second tubing 156′ and a vent 153. The vent 153 may couple or be connected to the first tubing 156.

In a number of embodiments, the wicking component 151 may function in one of two ways to feed the cleaning agent at a controlled rate into at least one of a drain tube or a drain pan of an HVAC assembly, wherein the controlled rate is regulated by an operating parameter of the HVAC assembly. The first function is a vacuum and the second function is positive pressure which are explained in detail below.

In a vacuum function system, in a number of embodiments, the vent 153 allows for a vacuum to be created within the wicking component 151. The wick 154 is wetted with cleaning agent via the reservoir 120. The second tubing 156′ may contain a flute that draws fluid cleaning agent into the drain tube or drain pan via the wicking component as a vacuum is created through use of the vent 153 drawing air into the first tubing 156. Air is then drawn into the second tubing 156′ and forces fluid cleaning agent from the wick 154 into the drain tube or drain pan via the vacuum that is created.

In a positive pressure function system, in a number of embodiments, the vent 153 allows for a positive pressure to be created within the wicking component 151. The wick 154 is wetted with cleaning agent via the reservoir 120. The second tubing 156′ may contain a trap printed within the base 152 that draws fluid cleaning agent into the drain tube or drain pan via the wicking component as a positive pressure is created through use of the vent 153 drawing air into the first tubing 156. Air is then drawn into the second tubing 156′ and forces fluid cleaning agent from the wick 154 into the drain tube or drain pan via the trap and positive pressure as air does not equal out with the vent 153, creating two pressures so air is forced up the first tubing 156 and down the second tubing 156′ and into the trap, drawing fluid from the wick 154 into the drain tube or drain pan.

In a number of embodiments, the reservoir 160 can have a void 161 creating an internal volume (or second volume), V_{S}. For purposes of embodiments described herein and as shown best in FIG. 1, the second volume, V_{S}, of the reservoir 160 may be at least about 0.1 L, such as, at least about 0.5 L, or at least about 1 L, or at least about 2 L, or at least about 5 L, or even at least about 10 L. According to still other embodiments, the second volume, V_{S}, of the reservoir 160 may be not greater than about 100 L, such as, not greater than about 50 L, or even not greater than about 25 L. It will be appreciated that the second volume, V_{S}, of the reservoir 160 may be within a range between any of the minimum and maximum values noted above. It will be further appreciated that the second volume, V_{S}, of the reservoir 160 may be any value between any of the minimum and maximum values noted above.

In a number of embodiments, as shown in FIG. 1, the reservoir 160 may include at least one port 162. In a number of embodiments, the at least one port 162 may include a plurality of ports. In a number of embodiments, the at least one port 162 may allow the cleaning agent 130 to be moved outside of the reservoir 160. In a number of embodiments, the at least one port 162 may be adapted for dispensing the cleaning agent 130. In a number of embodiments, the at least one port 162 may include at least one nozzle or needle for dispensing the cleaning agent 130 outside of the reservoir 160. In a number of embodiments, the at least one port 162 may include a plurality of nozzles or needles for dispensing the cleaning agent 130 outside of the reservoir 160. In a number of embodiments, the at least one port 162 or the reservoir 160 may include a filter 164 for filtering the cleaning agent 130. In a number of embodiments, the at least one port 162 or the reservoir 160 may include a vent 166 to vent to an environment outside of the reservoir 160. In a number of embodiments, the at least one port 162 or the reservoir 160 may include a sensor 168 to detect changes of the cleaning agent 130 within the at least one port 162 or the reservoir 160. It is contemplated herein that sensor 168 can measure luminescence, fluorescence, incandescence, a change in temperature, a change in pressure, a change in viscosity, a change in flowrate, or any other suitable changing characteristic in the cleaning agent 130 within or as it exits or enters the reservoir 160.

In a number of embodiments, the reservoir 160 may include an inlet 163 for depositing the cleaning agent 130 within the reservoir 160. In a number of embodiments, the inlet 163 may include a bore, spigot, nozzle, or any known variation for feeding cleaning agent 130 into a bag as known conventionally in the art. In a number of embodiments, the inlet 163 may be operatively connected to the first section of tubing 132 to form a connection between the reservoir 160 and the vessel 120.

In a number of embodiments, as shown in FIG. 1, the reservoir 160 may include a float valve 165 operatively connected to the reservoir 160 and the vessel 120. The float valve 165 may maintain a substantially constant fluid level within the reservoir 160. In a number of embodiments, the float valve 165 may have a generally polygonal cross-section (e.g. rectangular). In a number of variations, the float valve 165 may have a polygonal, oval, circular, semi-circular, or substantially circular cross-section. The float valve 165 may be disposed within the reservoir 160.

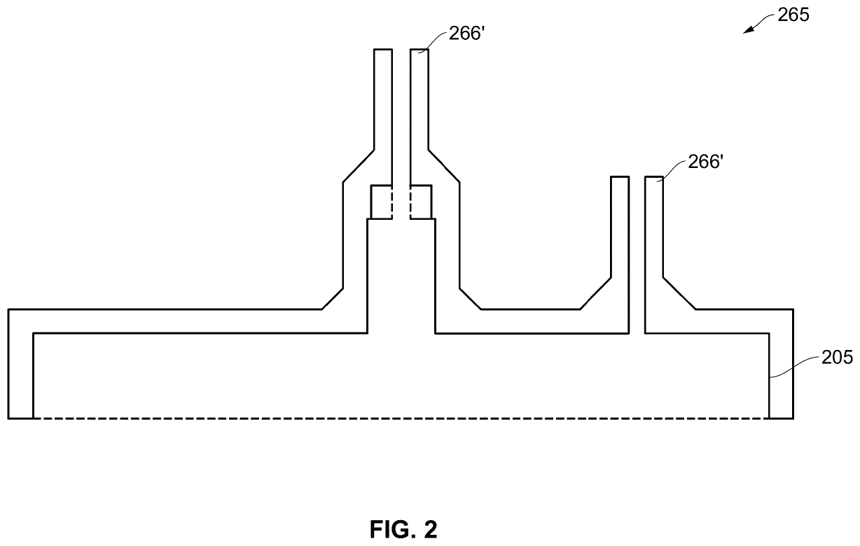

FIG. 2 illustrates a side cut-away view of a float valve for a cleaning assembly according to a number of embodiments of the present disclosure. As shown in FIG. 2, the float valve 265 may include a base 205. The base 205 may have generally polygonal cross-section (e.g. rectangular). In a number of variations, the base 205 may have a polygonal, oval, circular, semi-circular, or substantially circular cross-section. In a number of embodiments, the base 205 of the float valve 265 may be allowed to rise and fall according to the height of the cleaning agent within the void of the reservoir. In a number of embodiments, the base 205 of the float valve 265 may contact the inner walls of the reservoir.

In a number of embodiments, as shown in FIG. 2, the float valve 265 may further include at least one port 266. In a number of embodiments, the at least one port 266 may include a plurality of ports 266, 266′. In a number of embodiments, the at least one port 266 may allow the cleaning agent 130 to be moved through the reservoir. In a number of embodiments, the at least one port 266 may include at least one nozzle or needle for moving the cleaning agent through the reservoir.

In a number of embodiments, the base 205 of the float valve 265 may be allowed to rise and fall according to the height of the cleaning agent within the void of the reservoir. In a number of embodiments, the base 205 of the float valve 265 may contact the inner walls of the reservoir.

In a number of embodiments, referring back to FIG. 1, the reservoir 160 may include a drip chamber 167 operatively connected to the reservoir 160 and the vessel 120. In a number of embodiments, the drip chamber 167 may have a generally polygonal cross-section (e.g. rectangular). In a number of variations, the drip chamber 167 may have a polygonal, oval, circular, semi-circular, or substantially circular cross-section. The drip chamber 167 may be disposed within the reservoir 160.

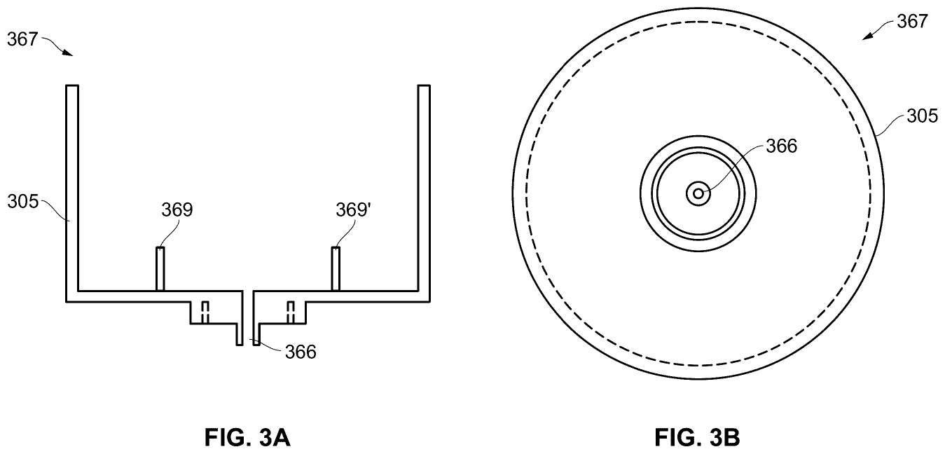

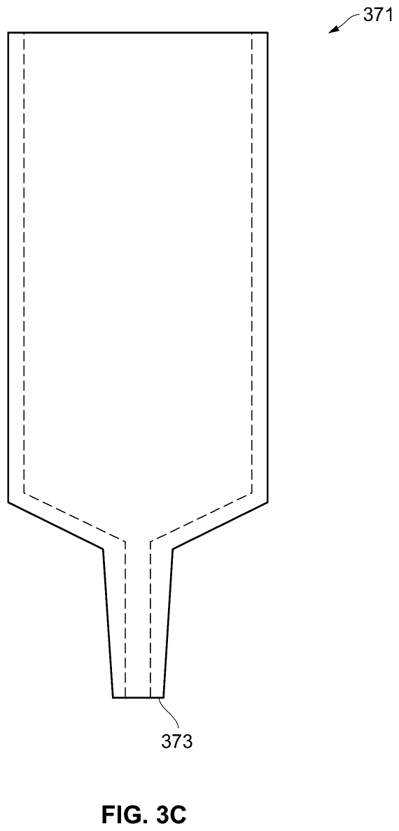

FIG. 3A illustrates a side cut-away view of a drip chamber for a cleaning assembly according to a number of embodiments of the present disclosure. FIG. 3B illustrates a top view of a drip chamber for a cleaning assembly according to a number of embodiments of the present disclosure. As shown in FIGS. 3A-3B, the drip chamber 367 may include a base 305. In a number of embodiments, the drip chamber 367 may further include at least one port 366. In a number of embodiments, the at least one port 366 may include a plurality of ports. In a number of embodiments, the at least one port 366 may allow the cleaning agent 130 to be moved out of the reservoir 160. In a number of embodiments, the at least one port 366 may include at least one nozzle or needle for moving the cleaning agent through the reservoir 160. Further, the drip chamber 367 may include flanges 369, 369′ which may stop the float valve from moving to the bottom of the reservoir.

FIG. 3C illustrates a side cut-away view of a drip chamber extension for a cleaning assembly according to a number of embodiments of the present disclosure. In a number of embodiments, as shown in FIG. 3C, the drip chamber 367 may include a drip chamber extension 371. In a number of embodiments, the drip chamber extension 371 may have a generally circular cross-section. In a number of variations, the drip chamber extension 371 may have a polygonal, oval, circular, semi-circular, or substantially circular cross-section. The drip chamber extension 371 may operatively connect to the port 366 of the drip chamber 367. In a number of embodiments, the drip chamber extension 371 may further include at least one port 373. In a number of embodiments, the at least one port 373 may include a plurality of ports. In a number of embodiments, the at least one port 373 may allow the cleaning agent to be moved out of the drip chamber 367 and/or the drip chamber extension 371.

Referring back to FIG. 1, the cleaning assembly 100 may further include a needle valve 180 operatively connected to the reservoir 160 and the vessel 120. In a number of embodiments, the needle valve 180 modulates a controlled rate of cleaning agent into the drain pan or drain tube by regulating the internal pressure differential within the HVAC assembly on the cleaning fluid in the automatic feed apparatus 110, as explained in further detail below. The needle valve 180 may open and close to allow fluid into the drain pan or drain tube based on the fluid level of the reservoir 160. In a number of embodiments, the needle valve 180 may have a generally polygonal cross-section (e.g. rectangular). In a number of variations, the needle valve 180 may have a polygonal, oval, circular, semi-circular, or substantially circular cross-section. In a number of embodiments, the needle valve 180 may be operatively connected to the drip chamber 167 of the reservoir 160 via tubing 130. In a number of embodiments, the needle valve 180 may be operatively connected to the drip chamber 167 of the reservoir 160 via a second section of tubing 134.

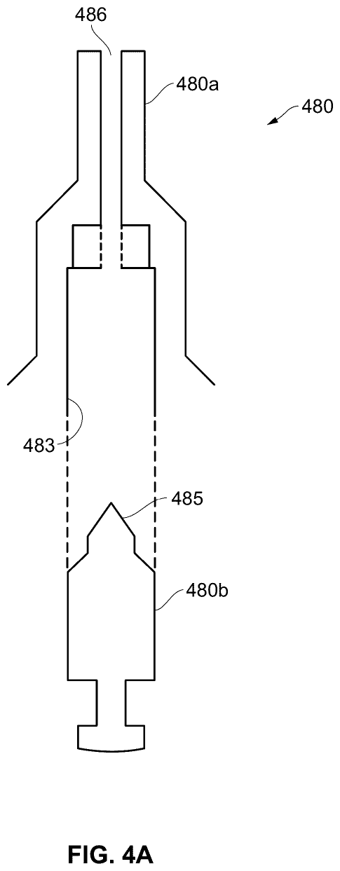

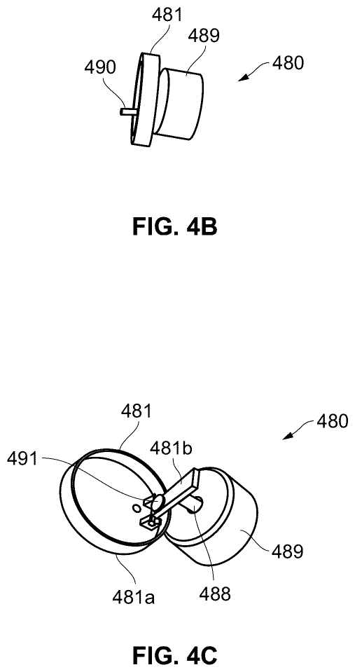

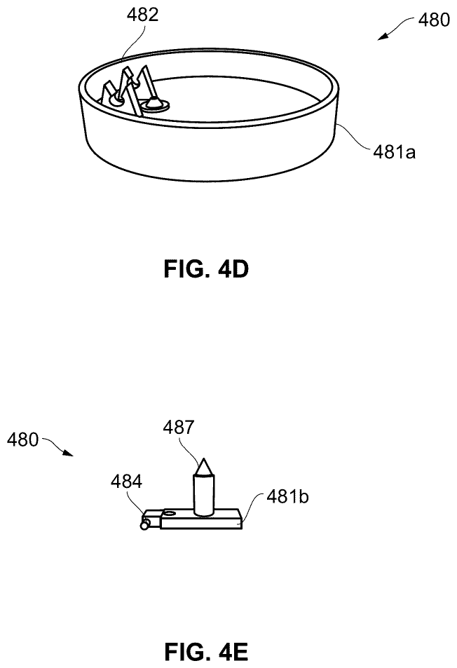

FIG. 4A illustrates a side cut-away view of a needle valve 480 for a cleaning assembly according to a number of embodiments of the present disclosure. As shown in FIG. 4A, the needle valve 480 may include a first needle valve component 480a and a second needle valve component 480b. In a number of embodiments, as shown in FIGS. 4A, the first component 480a of the needle valve 480 may further include at least one port 486. In a number of embodiments, the at least one port 486 may include a plurality of ports. In a number of embodiments, the at least one port 486 may allow the cleaning agent to be moved out of the needle valve 480 and into the drain tube or drain pan of an HVAC assembly. In a number of embodiments, the at least one port 486 may include at least one nozzle or needle for moving the cleaning agent.

In an embodiment, the first needle valve component 480a may include a first coupling component 483, and the second needle valve component 480b may include a second coupling component 485. The first coupling component 483 may pair with the second coupling component 485 to engage or couple the first needle valve component 480b to the second needle valve component 480b. The first coupling component 283 may pair or engage with the second coupling component 485 operatively connect the first needle valve component 480a to the second needle valve component 480b. As shown in FIG. 4A, the first coupling component 483 may include a female attachment in the form of a cavity and the second coupling component 485 can include a male attachment in the form of a projection to fit within the cavity. In an embodiment, at least one of the first coupling component 483 or the second coupling component 485 may include screw threads or other form of threads, bolts, battens, buckle, clamp, clip, flange, frog, grommet, hook-and-eye, latch, peg, nail, rivet, screw anchor, snap fastener, stitch, threaded fastener, tie, toggle bolt, wedge anchor, hole and screw combination, tongue-and-groove, or may be coupled a different way.

FIG. 4B illustrates a side view of an alternative embodiment of a needle valve for a cleaning assembly according to a number of embodiments of the present disclosure. FIG. 4C illustrates a side view of an alternative embodiment of a needle valve for a cleaning assembly according to a number of embodiments of the present disclosure. FIG. 4D illustrates a side view of a cap component for an alternative embodiment of a needle valve for a cleaning assembly according to a number of embodiments of the present disclosure. FIG. 4E illustrates a side view of a cap component of a needle valve for a cleaning assembly according to a number of embodiments of the present disclosure. As shown in FIGS. 4B-4E, the needle valve 480 may include a cap 481. The cap 481 may include a first cap component 481a and a second cap component 481b. As shown in FIGS. 4B-4C, the needle valve 480 may include a regulator 489. The regulator 489 may be allowed to open and close according to the height of the cleaning agent within the void of the reservoir 160. As shown, the regulator 489 may have a generally circular cross-section. In a number of variations, the regulator 489 may have a polygonal, oval, circular, semi-circular, or substantially circular cross-section. In an embodiment, the cap 481 may include at least one port 490. In a number of embodiments, the at least one port 490 may include at least one nozzle, void, bore, or needle for dispensing the cleaning agent 130 into the drain tube or drain pan. In a number of embodiments, the at least one port 122 may include a plurality of ports. In a number of embodiments, the cap 481 may include a seal 491 that covers the port 490 through operation of the regulator 489. The seal 491 may cover the port 490 to restrict or stop the cleaning agent from entering the drain tube or drain pan.

In an embodiment, the cap 481 may couple with the HVAC assembly for depositing the cleaning agent within the HVAC assembly. As shown best in FIG. 4D, the first cap component 481a may have a generally circular cross-section. In a number of variations, the first cap component 481a may have a polygonal, oval, circular, semi-circular, or substantially circular cross-section. As shown best in FIG. 4E, the second cap component 481b may have a generally polygonal cross-section. In a number of variations, the first cap component 481a may have a polygonal, oval, circular, semi-circular, or substantially circular cross-section.

In an embodiment, the first cap component 481a may include a first coupling component 482, and the second cap component 481b may include a second coupling component 484. The first coupling component 482 may pair with the second coupling component 484 to engage or couple the first cap component 481a to the second cap component 481b. The first coupling component 482 may pair or engage with the second coupling component 484 to operatively connect the cap 481 to the regulator 489 as discussed below. As shown in FIGS. 4B-4E, the first coupling component 482 may include a female attachment in the form of a groove and the second coupling component 484 can include a male attachment in the form of a snap fit bar to fit within the groove. In an embodiment, at least one of the first coupling component 482 or the second coupling component 484 may include screw threads or other form of threads, bolts, battens, buckle, clamp, clip, flange, frog, grommet, hook-and-eye, latch, peg, nail, rivet, screw anchor, snap fastener, stitch, threaded fastener, tie, toggle bolt, wedge anchor, hole and screw combination, tongue-and-groove, or may be coupled a different way. This may allow the second cap component 481b to translate about a pivot of the first coupling component 482 for better engagement with the float valve regulator 489.

In a number of embodiments, second cap component 481b may include a third coupling component 487 and the float valve regulator 489 may include a fourth coupling component 488. The third coupling component 487 may pair with the fourth coupling component 488 to engage or couple the second cap component 281b to the float valve regulator 489. As shown in FIGS. 4B-4C, the third coupling component 487 may include a male attachment in the form of a tongue or projection and the fourth coupling component 488 can include a female attachment in the form of a groove. In an embodiment, at least one of the third coupling component 487 or the fourth coupling component 488 may include screw threads or other form of threads, bolts, battens, buckle, clamp, clip, flange, frog, grommet, hook-and-eye, latch, peg, nail, rivet, screw anchor, snap fastener, stitch, threaded fastener, tie, toggle bolt, wedge anchor, hole and screw combination, tongue-and-groove, or may be coupled a different way. This may allow the cap component 481 to allow for the float valve regulator 489 to rise and fall according to the required cleaning agent in the drain plan, as explained further below.

As stated above, the tubing can be replaced by a wicking component. In a number of embodiments, the wicking component may feed the cleaning agent into the drain tube or drain pan of the HVAC assembly. In a number of embodiments, the wicking component may replace the needle valve 180.

In an embodiment herein, at least one of the cleaning assembly 100, the vessel 120, the reservoir 160, the needle valve 180, the tubing/wicking component 132, or components thereof may include a metal. According to certain embodiments, the metal may include iron, copper, titanium, tin, aluminum, alloys thereof, or may be another type of metal.

In some embodiments, at least one of the cleaning assembly 100, the vessel 120, the reservoir 160, the needle valve 180, the tubing/wicking component 132, or components thereof may be formed from a ceramic material comprising at least one metallic element comprising aluminum, boron, copper, zircon, chromium, silicon, titanium, hafnium, tungsten, tantalum, yttrium, or a combination thereof. In some embodiments, at least one of the cleaning assembly 100, the vessel 120, the reservoir 160, the needle valve 180, the tubing/wicking component 132, or components thereof may be formed from a ceramic material comprising at least one metallic clement comprising aluminum, boron, copper, zircon, chromium, silicon, titanium, hafnium, tungsten, tantalum, yttrium, or a combination thereof, and combined with carbon, oxygen, or nitrogen, or a combination thereof. In some embodiments, the at least one of the cleaning assembly 100, the vessel 120, the reservoir 160, the needle valve 180, the tubing/wicking component 132, or components thereof may be formed from a ceramic material comprising aluminum oxide, aluminum nitride, boron nitride, copper oxide, silicon nitride, silicon oxide, zirconium oxide, zirconium dioxide, or a combination thereof.

In a number of embodiments, at least one of the cleaning assembly 100, the vessel 120, the reservoir 160, the needle valve 180, the tubing/wicking component 132, or components thereof can be formed of a material including a polymer. In an embodiment, at least one of the cleaning assembly 100, the vessel 120, the reservoir 160, the needle valve 180, the tubing/wicking component 132, or components thereof may include, but are not limited to, thermoplastic, thermosets, fluoropolymers, and combinations thereof. In an embodiment, at least one of the cleaning assembly 100, the vessel 120, the reservoir 160, the needle valve 180, the tubing/wicking component 132, or components thereof can be formed of a thermoplastic elastomer, silicone, or combinations thereof.

In an embodiment, at least one of the cleaning assembly 100, the vessel 120, the reservoir 160, the needle valve 180, the tubing/wicking component 132, or components thereof may include a blend of polymers or polymeric polymers including a thermoplastic elastomeric hydrocarbon block copolymer, a polyether-ester block co-polymer, a thermoplastic polyamide elastomer, a thermoplastic polyurethane elastomer, a thermoplastic polyolefin elastomer, a thermoplastic vulcanizate, an olefin-based co-polymer, an olefin-based ter-polymer, a polyolefin plastomer, or combinations thereof. In an embodiment, at least one of the cleaning assembly 100, the vessel 120, the reservoir 160, the needle valve 180, the tubing/wicking component 132, or components thereof may include a styrene based block copolymer such as styrene-butadiene, styrene-isoprene, blends or mixtures thereof, mixtures thereof, and the like. Exemplary styrenic thermoplastic elastomers include triblock styrenic block copolymers (SBC) such as styrene-butadiene-styrene (SBS), styrene-isoprene-styrene (SIS), styrene-ethylene butylene-styrene (SEBS), styrene-ethylene propylene-styrene (SEPS), styrene-ethylene-ethylene-butadiene-styrene (SEEBS), styrene-ethylene-ethylene-propylene-styrene (SEEPS), styrene-isoprene-butadiene-styrene (SIBS), or combinations thereof.

In an embodiment, at least one of the cleaning assembly 100, the vessel 120, the reservoir 160, the needle valve 180, the tubing/wicking component 132, or components thereof may include a polyolefin polymer. A typical polyolefin may include a homopolymer, a copolymer, a terpolymer, an alloy, or any combination thereof formed from a monomer, such as ethylene, propylene, butene, pentene, methyl pentene, hexene, octene, or any combination thereof. In an embodiment, the polyolefin polymer may be copolymers of ethylene with propylene or alpha-olefins or copolymers of polypropylene with ethylene or alpha-olefins made by metallocene or non-metallocene polymerization processes. Commercial polyolefin examples include Affinity™, Engage™, Flexomer™, Versify™, Infuse™, Exact™, Vistamaxx™, Softel™ and Tafmer™, Notio™ produced by Dow, ExxonMobil, Londel-Basell and Mitsui. In an embodiment, the polyolefin polymer may include copolymers of ethylene with polar vinyl monomers such as acetate (EVA), acrylic acid (EAA), methyl acrylate (EMA), methyl methacrylate (EMMA), ethyl acrylate (EEA) and butyl acrylate (EBA).

In an embodiment, at least one of the cleaning assembly 100, the vessel 120, the reservoir 160, the needle valve 180, the tubing/wicking component 132, or components thereof may include a fluorinated polymer. In an embodiment, at least one of the cleaning assembly 100, the vessel 120, the reservoir 160, the needle valve 180, the tubing/wicking component 132, or components thereof may include a polymer including at least one of ethylene-tetrafluoroethylene, tetrafluoro-ethylene-perfluoro (methyl vinyl ether), polyvinylidene fluoride, ethylene-chlorotrifluoroethylene, polyimide, polyamidimide, polyphenylene sulfide, polyethersulfone, polyphenylene sulfone, liquid crystal polymers, polyetherketone, polyether ether ketones, aromatic polyesters (Ekonol), of polyether-ether-ketone, polyetherketone, liquid crystal polymer, polyamide, polyethylene/UHMPE, polypropylene, polystyrene, styrene butadiene copolymers, polyesters, polycarbonate, polyacrylonitriles, polyamides, styrenic block copolymers, ethylene vinyl alcohol copolymers, ethylene vinyl acetate copolymers, polyesters grafted with maleic anhydride, poly-vinylidene chloride, aliphatic polyketone, liquid crystalline polymers, ethylene methyl acrylate copolymer, ethylene-norbomene copolymers, polymethylpentene and ethylene acrylic acid copolymer, mixtures, copolymers and any combination thereof.

Further, in an embodiment, at least one of the cleaning assembly 100, the vessel 120, the reservoir 160, the needle valve 180, the tubing/wicking component 132, or components thereof can include one or more additives. For example, the one or more additives can include a plasticizer, a catalyst, a silicone modifier, a silicon component, a stabilizer, a curing agent, a lubricant, a colorant, a filler, a blowing agent, another polymer as a minor component, or a combination thereof. In a particular embodiment, the plasticizer can include mineral oil.

In an embodiment, at least one of the cleaning assembly 100, the vessel 120, the reservoir 160, the needle valve 180, the tubing/wicking component 132, or components thereof can be formed as a single piece or may be formed as multiple pieces. In an embodiment, at least one of the cleaning assembly 100, the vessel 120, the reservoir 160, the needle valve 180, the tubing/wicking component 132, or components thereof can be a molded component. In an embodiment, at least one of the cleaning assembly 100, the vessel 120, the reservoir 160, the needle valve 180, the tubing/wicking component 132, or components thereof can be formed through over-molding or other methods known in the art. In an embodiment, the polymer or polymeric blend included in at least one of the cleaning assembly 100, the vessel 120, the reservoir 160, the needle valve 180, the tubing/wicking component 132, or components thereof may be processed by any known method to form the polymeric mixture. The polymer or polymeric blend may be melt processed by dry blending or compounding. The dry blend may be in powder, granular, or pellet form. The blend can be made by a continuous twin-screw compounding process or batch related Banbury process. Pellets of these mixtures may then be fed into a single screw extruder to make articles such as flexible tubing products. Mixtures can also be mixed in a single-screw extruder equipped with mixing elements and then extruded directly into articles such as tubing products. In a particular embodiment, the mixture can be melt processed by any method envisioned known in the art such as laminating, casting, molding, extruding, and the like. In an embodiment, the mixture can be injection molded.

In an embodiment, the polymer or polymeric blend of at least one of the cleaning assembly 100, the vessel 120, the reservoir 160, the needle valve 180, the tubing/wicking component 132, or components thereof may be formed into a single layer article, a multi-layer article, or can be laminated, coated, or formed on a substrate to form at least one of the cleaning assembly 100, the vessel 120, the reservoir 160, the needle valve 180, the tubing/wicking component 132, or components thereof. Multi-layer articles may include layers such as reinforcing layers, adhesive layers, barrier layers, chemically resistant layers, metal layers, any combination thereof, and the like. The polymer or polymeric blend can be formed into any useful shape such as film, sheet, tubing, and the like to form at least one of the cleaning assembly 100, the vessel 120, the reservoir 160, the needle valve 180, the tubing/wicking component 132, or components thereof.

In embodiment, at least one of the cleaning assembly 100, the vessel 120, the reservoir 160, the needle valve 180, the tubing/wicking component 132, or components thereof may have further desirable physical and mechanical properties. For instance, at least one of the cleaning assembly 100, the vessel 120, the reservoir 160, the needle valve 180, the tubing/wicking component 132, or components thereof may appear transparent or at least translucent. For instance, at least one of the cleaning assembly 100, the vessel 120, the reservoir 160, the needle valve 180, the tubing/wicking component 132, or components thereof may have a light transmission greater than about 2%, or greater than about 5% in the visible light wavelength range. In particular, the resulting articles have desirable clarity or translucency. In addition, at least one of the cleaning assembly 100, the vessel 120, the reservoir 160, the needle valve 180, the tubing/wicking component 132, or components thereof have advantageous physical properties, such as a balance of any one or more of the properties of hardness, flexibility, surface lubricity, tensile strength, elongation, Shore A hardness, gamma resistance, weld strength, and seal integrity to an optimum level.

In an embodiment, at least one of the cleaning assembly 100, the vessel 120, the reservoir 160, the needle valve 180, the tubing/wicking component 132, or components thereof may have desirable heat stability properties. Applications for the polymer or polymeric blend are numerous. In particular, the polymer or polymeric blend may be non-toxic, making the material useful for any application where no toxicity is desired. For example, the polymer or polymeric blend may be substantially free of plasticizers or other low-molecular weight extenders that can be leached into the fluids it transfers. “Substantially free” as used herein refers to a polymeric mixture having a total organic content (TOC) (measured in accordance to ISO 15705 and EPA 410.4) of less than about 100 ppm. Further, the polymer or polymeric blend has biocompatibility and animal derived component-free formulation ingredients. For instance, the polymeric mixture has potential for FDA, USP, EP, ISO, and other regulatory approvals. In an exemplary embodiment, the polymer or polymeric blend may be used in applications such as industrial, medical, health care, biopharmaceutical, pharmaceutical, drinking water, food & beverage, laboratory, dairy, and the like. In an embodiment, the polymeric mixture may be used in applications where low temperature resistance is desired. In an embodiment, the polymer or polymeric blend may also be safely disposed as it generates substantially no toxic gases when incinerated and leaches no plasticizers into the environment if land filled.

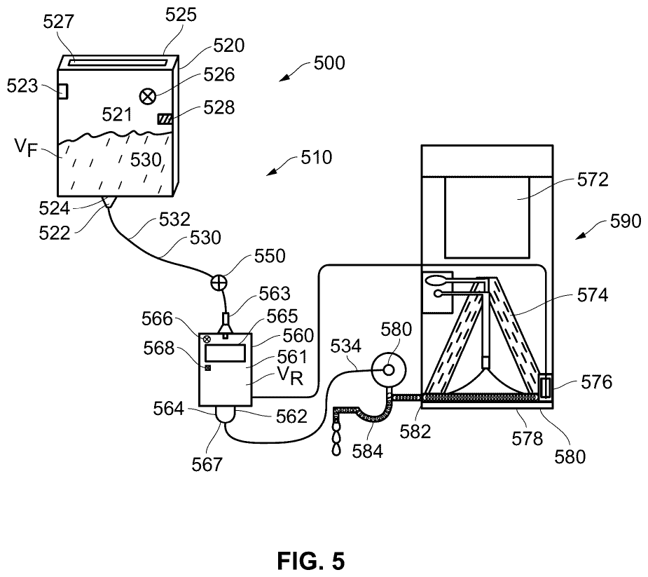

FIG. 5 illustrates a schematic view of a cleaning assembly and its use with an exemplary HVAC assembly according to a number of embodiments of the present disclosure. As shown in FIG. 5, the HVAC assembly 590 may include blower system 572, evaporator coils 574, at least one sensor 576, drain pan 578, and air filter 580. In a number of embodiments, HVAC assembly 590 may further include a drain outlet 582 and drain tube (or drip tube) 584. As discussed above, the cleaning assembly 500 may be coupled to the HVAC assembly 590. In an embodiment, the cleaning assembly 500 may be coupled to the HVAC assembly 590 on an exterior of the HVAC assembly 590. In an embodiment, the cleaning assembly 500 may be coupled to the HVAC assembly 590 on an interior of the HVAC assembly 590 via an attachment means, which may include a magnet, adhesive, or mechanical fastener (e.g. hook, shelf, etc.). In a number of embodiments, the cleaning assembly 500 may be coupled to the HVAC assembly 590 on an exterior of the HVAC assembly 590 via an attachment means, which may include a magnet, adhesive, or mechanical fastener (e.g. hook, shelf, etc.). The cleaning assembly 500 may include a second section of tubing 534 that operatively connects to a needle valve 580 that operatively connects with drain tube 584. In an embodiment, the second section of tubing 534 may deliver the cleaning agent directly into drain tube 584 via the needle valve 580. The cleaning agent may enter the drain pan 578 and then subsequently may drain from drain outlet 582 to drain tube 584. The cleaning agent may prevent or eliminate the growth of microorganisms, algae, gunk and/or other solid material on drain pan 578, drain outlet 582, and drain tube 584 allowing both to remain clean.

As known conventionally in HVAC assemblies, the blower system 572 and evaporator coils 574 may be paired with a supply duct, an output duct, and a return duct (not shown). In a number of embodiments, the flow of air through the blower system 572 of the HVAC assembly 590 may create a static pressure differential that is close to the drain pan 578 due to the location of the drain pan 578 near the blower system 572. In this way, the pressure differential may draw the cleaning agent into the drain pan 578 and/or the drain tube 584 at a rate controlled by an operative parameter of the HVAC assembly (e.g. the pressure differential) via the automatic feed apparatus 510. In this way, the pressure differential may draw the cleaning agent into the drain pan 578 through the drain tube 584 at a controlled rate in a range of 0.01-0.2 mL/min into the drain tube of the HVAC assembly. It will be appreciated that the controlled rate may be within a range between any of the minimum and maximum values noted above. It will be further appreciated that the controlled rate may be any value between any of the minimum and maximum values noted above. Further, the needle valve 580 of the cleaning assembly 500 may be in substantially a same latitudinal plane as the reservoir 560.

In a number of embodiments, at least one sensor 576 may be connected to the cleaning assembly 500. At least one sensor 576 may be activated and sends a signals to the cleaning assembly 500. At least one electronic control unit may be connected to the cleaning assembly 500 to allow a user to manually or automatically control a feed rate of cleaning agent into the drain pan of the HVAC assembly, receiving signals from at least one sensor 576 to regulate the cleaning assembly 500.

A method for using the cleaning assembly may include: providing a drain tube or a drain pan of an HVAC assembly; providing a cleaning assembly including a cleaning agent including at least one of a fungicide, bactericide, viricide, or an algaecide, and an automatic feed apparatus, where the automatic feed apparatus is adapted to feed cleaning agent at a controlled rate into at least one of the drain tube or the drain pan of an HVAC assembly; and feeding cleaning agent from the automatic feed apparatus into the drain tube, where the controlled rate is regulated by an operating parameter of the HVAC assembly.

Use of the cleaning assembly may provide increased benefits in several applications for HVAC assemblies in fields such as, but not limited to, industrial, medical, health care, biopharmaceutical, pharmaceutical, drinking water, food & beverage, laboratory, dairy, or other types of applications. Notably, the use of cleaning assemblies according to embodiments herein may provide an ease of cleaning drain pans and drain lines for HVAC assemblies that don't require oversight and don't overuse the cleaning agent, as is done with conventional cleaning assemblies that are gravity fed or smart-controlled. Further, the use of cleaning assemblies according to embodiments herein may provide improved performance and efficiency of the HVAC assembly due to the sanitation of the drain pan and drain tube.

Many different aspects and embodiments are possible. Some of those aspects and embodiments are described below. After reading this specification, skilled artisans will appreciate that those aspects and embodiments are only illustrative and do not limit the scope of the present invention.

### Embodiment 1

A cleaning assembly comprising: a cleaning agent comprising at least one of a fungicide, bactericide, viricide, or an algaecide, and an automatic feed apparatus, wherein the automatic feed apparatus is adapted to feed the cleaning agent at a controlled rate into at least one of drain tube or a drain pan of an HVAC assembly, wherein the controlled rate is regulated by an operating parameter of the HVAC assembly.

### Embodiment 2

An HVAC assembly comprising: a drain tube or a drain pan; and a cleaning assembly comprising: a cleaning agent comprising at least one of a fungicide, bactericide, viricide, or an algaecide, and an automatic feed apparatus, wherein the automatic feed apparatus is adapted to feed the cleaning agent at a controlled rate into at least one of the drain tube or the drain pan of an HVAC assembly, wherein the controlled rate is regulated by an operating parameter of the HVAC assembly.

### Embodiment 3

A method comprising: providing a drain tube or a drain pan of an HVAC assembly; providing a cleaning assembly comprising a cleaning agent comprising at least one of a fungicide, bactericide, viricide, or an algaecide, and an automatic feed apparatus, wherein the automatic feed apparatus is adapted to feed the cleaning agent at a controlled rate into at least one of the drain tube or the drain pan of an HVAC assembly; and feeding cleaning agent from the automatic feed apparatus into at least one of the drain tube or the drain pan, wherein the controlled rate is regulated by an operating parameter of the HVAC assembly.

### Embodiment 4

The cleaning assembly, HVAC assembly, or method according to any of the preceding embodiments, wherein the cleaning agent is fed at a controlled rate in a range of 0.01-0.2 mL/min into the drain tube of the HVAC assembly.

### Embodiment 5

The cleaning assembly, HVAC assembly, or method according to any of the preceding embodiments, wherein the controlled rate is regulated by an internal pressure differential within the HVAC assembly.

### Embodiment 6

The cleaning assembly, HVAC assembly, or method according to embodiment 5, wherein the internal pressure differential is provided by a blower within the HVAC assembly.

### Embodiment 7

The cleaning assembly, HVAC assembly, or method according to any of the preceding embodiments, wherein the automatic feed apparatus comprises an electronic control unit allowing a user to manually or automatically control a feed rate of cleaning agent into the drain pan of the HVAC assembly.

### Embodiment 8

The cleaning assembly, HVAC assembly, or method according to any of the preceding embodiments, wherein the drain tube is operatively connected to the drain pan of the HVAC assembly, wherein the cleaning agent is fed directly into the drain pan of the HVAC assembly via the automatic feed apparatus.

### Embodiment 9

The cleaning assembly, HVAC assembly, or method according to any of the preceding embodiments, wherein the cleaning agent comprises hydrogen peroxide.

### Embodiment 10

The cleaning assembly, HVAC assembly, or method according to embodiment 9, wherein the cleaning agent maintains a cleaning agent composition of 2-50 ppm within the drain tube or the drain pan.

### Embodiment 11

The cleaning assembly, HVAC assembly, or method according to any of the preceding embodiments, wherein the cleaning agent comprises a fluid.

### Embodiment 12

The cleaning assembly, HVAC assembly, or method according to any of the preceding embodiments, wherein the cleaning agent comprises a particulate.

### Embodiment 13

The cleaning assembly, HVAC assembly, or method according to any of the preceding embodiments, wherein the automatic feed apparatus is exterior to the HVAC assembly.

### Embodiment 14

The cleaning assembly, HVAC assembly, or method according to any of the preceding embodiments, wherein the automatic feed apparatus is interior to the HVAC assembly.

### Embodiment 15

The cleaning assembly, HVAC assembly, or method according to any of the preceding embodiments, wherein the automatic feed apparatus further comprises a vessel for housing the cleaning agent.

### Embodiment 16

The cleaning assembly, HVAC assembly, or method according to embodiment 15, wherein the automatic feed apparatus further comprises a reservoir comprising a float valve operatively connected to the vessel.

### Embodiment 17

The cleaning assembly, HVAC assembly, or method according to embodiment 16, wherein the float valve maintains a substantially constant fluid level within the reservoir.

### Embodiment 18

The cleaning assembly, HVAC assembly, or method according to embodiment 17, wherein the automatic feed apparatus further comprises a drip chamber operatively connected to the reservoir.

### Embodiment 19

The cleaning assembly, HVAC assembly, or method according to embodiment 18, wherein the automatic feed apparatus further comprises a needle valve operatively connected to the drip chamber and the drain tube or the drain pan.

### Embodiment 20

The cleaning assembly, HVAC assembly, or method according to embodiment 18, wherein the needle valve modulates the controlled rate of cleaning agent into the drain pan or drain tube by regulating the internal pressure differential within the HVAC assembly on the cleaning fluid in the automatic feed apparatus.

### Embodiment 21

The cleaning assembly, HVAC assembly, or method according to embodiment 18, wherein the needle valve is in substantially a same latitudinal plane as the reservoir.

### Embodiment 22

The cleaning assembly, HVAC assembly, or method according to any of embodiments 15-21, wherein the vessel is exterior to the HVAC assembly.

### Embodiment 23

The cleaning assembly, HVAC assembly, or method according to any of embodiments 15-22, wherein at least one of the vessel or the reservoir comprises an attachment means for attaching to the HVAC assembly.

### Embodiment 24

The cleaning assembly, HVAC assembly, or method according to embodiment 23, wherein the attachment means comprises a fastener or a magnetic component.

### Embodiment 25

The cleaning assembly, HVAC assembly, or method according to any of the preceding embodiments, wherein automatic feed apparatus comprises tubing operatively connecting at least two of the vessel, drip chamber, float valve, reservoir, needle valve, drain pan, or drain tube.

### Embodiment 26

The cleaning assembly, HVAC assembly, or method according to embodiment 25, wherein the tubing comprises a flexible polymer.

### Embodiment 27

The cleaning assembly, HVAC assembly, or method according to any of embodiments 15-26, wherein the vessel comprises a flexible polymer.

### Embodiment 28

The cleaning assembly, HVAC assembly, or method according to any of embodiments 16-27, wherein the reservoir comprises a polymer.

### Embodiment 29

The cleaning assembly, HVAC assembly, or method according to any of the preceding embodiments, wherein automatic feed apparatus comprises a wicking component operatively connecting at least two of the vessel, drip chamber, float valve, reservoir, needle valve, drain pan, or drain tube.

### Embodiment 30

The cleaning assembly, HVAC assembly, or method according to embodiment 29, wherein the wicking component is made of a polymer.

### Embodiment 31

The cleaning assembly, HVAC assembly, or method according to embodiment 29, wherein the wicking component operatively connects the vessel to the reservoir.

### Embodiment 32

The cleaning assembly, HVAC assembly, or method according to embodiment 29, wherein the wicking component operatively connects the reservoir to the drain tube or drain pan.

Note that not all of the activities described above in the general description or the examples are required, that a portion of a specific activity may not be required, and that one or more further activities may be performed in addition to those described. Still further, the order in which activities are listed is not necessarily the order in which they are performed.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

Note that not all of the activities described above in the general description or the examples are required, that a portion of a specific activity may not be required, and that one or more further activities may be performed in addition to those described. Still further, the order in which activities are listed are not necessarily the order in which they are performed.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

After reading the specification, skilled artisans will appreciate that certain features are, for clarity, described herein in the context of separate embodiments, may also be provided in combination in a single embodiment. Conversely, various features that are, for brevity, described in the context of a single embodiment, may also be provided separately or in any subcombination. Further, references to values stated in ranges include each and every value within that range.

What is claimed:

1. A cleaning assembly comprising:
a cleaning agent comprising at least one of a fungicide, bactericide, viricide, or an algaecide, and
an automatic feed apparatus, wherein the automatic feed apparatus is adapted to feed the cleaning agent at a controlled rate into at least one of a drain tube or a drain pan of an HVAC assembly, wherein the controlled rate is regulated by an operating parameter of the HVAC assembly.

2. An HVAC assembly comprising:
a drain tube or a drain pan; and
a cleaning assembly comprising:
a cleaning agent comprising at least one of a fungicide, bactericide, viricide, or an algaecide, and
an automatic feed apparatus, wherein the automatic feed apparatus is adapted to feed the cleaning agent at a controlled rate into at least one of the drain tube or the drain pan of an HVAC assembly, wherein the controlled rate is regulated by an operating parameter of the HVAC assembly.

3. A method comprising:
providing a drain tube or a drain pan of an HVAC assembly;
providing cleaning assembly comprising:
a cleaning agent comprising at least one of a fungicide, bactericide, viricide, or an algaecide, and
an automatic feed apparatus, wherein the automatic feed apparatus is adapted to feed the cleaning agent at a controlled rate into at least one of the drain tube or the drain pan of an HVAC assembly; and
feeding cleaning agent from the automatic feed apparatus into the drain tube, wherein the controlled rate is regulated by an operating parameter of the HVAC assembly.

4. The HVAC assembly of claim 2, wherein the cleaning agent is fed at a controlled rate in a range of 0.01-0.2 mL/min into the drain tube of the HVAC assembly.

5. The HVAC assembly of claim 2, wherein the controlled rate is regulated by an internal pressure differential within the HVAC assembly.

6. The HVAC assembly of claim 5, wherein the internal pressure differential is provided by a blower within the HVAC assembly.

7. The cleaning assembly of claim 1, wherein the automatic feed apparatus comprises an electronic control unit allowing a user to manually or automatically control a feed rate of cleaning agent into the drain pan of the HVAC assembly.

8. The HVAC assembly of claim 2, wherein the drain tube is operatively connected to the drain pan of the HVAC assembly, wherein the cleaning agent is fed directly into the drain pan of the HVAC assembly via the automatic feed apparatus.

9. The cleaning assembly of claim 1, wherein the cleaning agent comprises hydrogen peroxide.

10. The cleaning assembly of claim 1, wherein cleaning agent comprises a fluid.

11. The cleaning assembly of claim 1, wherein cleaning agent comprises a particulate.

12. The cleaning assembly of claim 1, wherein the automatic feed apparatus further comprises a vessel for housing the cleaning agent.

13. The cleaning assembly of claim 1, wherein automatic feed apparatus comprises a wicking component operatively connecting the vessel and the drain pan.

14. The cleaning assembly of claim 13, wherein the vessel is inverted and placed over the wicking component and coupled via threadings.

15. The cleaning assembly of claim 13, wherein the wicking component comprises a base, a plurality of tubes, and a wick.

16. The cleaning assembly of claim 15, wherein at least one tube of the plurality of tubes at least partially houses the wick and feeds it into the drain tube or drain pan.

17. The cleaning assembly of claim 15, wherein at least one tube of the plurality of tubes is coupled to a vent in the base.

18. The cleaning assembly of claim 15, wherein the base is coupled to the drain tube via an L-intersection of tubing or piping.

19. The cleaning assembly of claim 15, wherein the second tubing comprises a flute and fluid is forced from the wick not the drain tube or drain pan through a vacuum.

20. The cleaning assembly of claim 15, wherein the base comprises a trap and fluid is forced from the wick not the drain tube or drain pan through positive pressure.
